(19) United States
(12) Patent Application Publication
(10) Pub. No.: US 2002/0169970 A1
(43) Pub. Date: Nov. 14, 2002

(54) Secure time reference for content players

(76) Inventor: Brant L. Candelore, Escondido, CA (US)

Correspondence Address: WAGNER, MURABITO & HAO LLP, Two North Market Street, Third Floor, San Jose, CA, 95113, US

(21) Appl. No.: 09/854,021

(22) Filed: May 10, 2001

(51) Int. Cl. H04L 9/32; G06F 11/30

(52) U.S. Cl. 713/193

(57) ABSTRACT

The present invention discloses a method and system for providing a secure time reference for content players. Specifically, the present invention pertains to a method of inserting a time reference signal into a delivery system for the purpose of affecting the playback of delivered content. Players of content, which consists of movies, songs or other copyrighted intellectual property and for this purpose would contain appropriate coding, can use the secure time reference to limit or enable playback. This provides a measure of control of the intellectual property and leads the way to, among other things, effective online movie rental or short-term song listening. It is appreciated that the content involved could be delivered to the consumer by internet, cable, telephone, direct satellite, packaged media, or any other means.

### FIELD OF THE INVENTION

The present invention relates to a method for providing a secure, non-local, time reference for networked content players.

### BACKGROUND OF THE INVENTION

Content, which includes any intellectual property such as software, songs and movies, is delivered in many forms to content players, the devices which present it in a form that is usable for the end user. Content can be delivered via internet, satellite, cable, phone line, wireless network, packaged media, or any other means. Some content may have time-based restrictions on descrambling, playability or recordability.

For one example, a movie on videotape, one of many forms of content delivery, can be rented at a video store and taken home by the renter for a specified period of time. During that period, the renter and any number of other viewers may watch the movie as many times as they wish. When the specified time is up, the renter must either return the rented video tape or his or her account will be assessed to pay for more time.

The much sought-after goal of content delivery is the watch-on-demand movie online (or play-on-demand music), where the content is delivered as it is played. Only slightly less desirable is online movie rental, where a movie is delivered via the internet to the movie renter's recording device and content player. The renter, who has paid a fee for the delivery, may watch the movie as many times as he or she wishes. Unlike the rented videotape, an internet-delivered movie does not have to be returned to a video store; the renter has no time constraints on watchability, or playback, of the movie and only the ineffective copyright restriction against copying it. This means that internet delivery is essentially a sale, where the provider loses all control of the content when it is delivered. The provider may have to charge a higher price for the delivery to make up for lost revenue represented by “pirated” copies. If the networked content player had a means of determining time, however, and the internet-delivered movie were coded with time-based playback access criteria, then when a rental term was reached, the movie could no longer be played.

Virtually all content players, such as the movie player in the example, have built-in clocks. However, built-in clocks can be reset, “spoofing” any time-based content playback protection. Different content players can also be located in different time zones than that in which the content's time-based constraint was set. They also require some means of keeping power supplied, such as batteries or line power. Batteries have limited life, particularly in hostile environments, especially with high temperatures, and must be occasionally replaced at an additional cost. Line power is not always available. Furthermore, a time reference function that requires a highly accurate coordination between a local time reference and another clock might be compromised by drift caused by unavoidable inaccuracies in the clock reference. Though a periodic update of the clock reference could remove the inaccuracy, that process would require some security to avoid the intentional spoofing that local clock resetting achieves.

If a local time reference were to be used to restrain the behavior of users, some users might be tempted to alter the local time. The local time clock's hardware and software would then need their own expensive, tamper-resistant, security perimeter.

What is required, then, is a time reference for content players. Furthermore, a time reference is needed that is secure against hacking and spoofing, is independently readable by the content player and is sufficiently accurate to avoid clock-drift problems.

### SUMMARY OF THE INVENTION

Embodiments of the present invention pertain to a method for providing a secure time reference from a remote provider to a content player. This method provides a time reference that is secure against hacking and spoofing, is independently readable by the content player and is sufficiently accurate to avoid clock-drift problems.

Embodiments of the present invention disclose a method and system for providing a secure time reference for content players. Specifically, the present invention pertains to a method of inserting a time reference signal into a delivery system for the purpose of affecting the playback of delivered content. Players of content, which consists of movies, software, data, songs or other intellectual property and for this purpose would contain appropriate coding, can use a secure time reference to limit or enable playback. This provides a measure of control of the intellectual property, leading the way to, among other things, effective online movie rental or short-term song listening. It is appreciated that the content involved could be delivered to the consumer by internet, cable, direct satellite, packaged media, or any other means.

A method is disclosed, in one embodiment, for providing a secure time reference to a remote content playing apparatus, which comprises the steps of generating a clock signal at a source, encrypting the clock signal, transmitting the encrypted clock signal to a remote content player, receiving the encrypted clock signal at the remote content player, decrypting the encrypted clock signal at the remote content player, and altering the playability of the content on the content player by referring to the clock signal.

### BRIEF DESCRIPTION OF THE DRAWINGS

The operation of this invention can be best visualized by reference to the drawings.

FIG. 1 illustrates one implementation of a time server in accordance with one embodiment of the present invention.

FIG. 2A illustrates one implementation of a content playing apparatus in accordance with one embodiment of the present invention.

FIG. 2B illustrates another implementation of a content playing apparatus in accordance with one embodiment of the present invention.

FIG. 2C illustrates one implementation of a time reference signal receiving device in accordance with one embodiment of the present invention.

FIG. 3 illustrates one implementation of a system using a secure time reference in accordance with one embodiment of the present invention.

FIG. 4 illustrates one implementation of a system using a secure time reference in accordance with one embodiment of the present invention.

FIG. 5 illustrates one implementation of a system using a secure time reference in accordance with one embodiment of the present invention.

FIG. 6 illustrates one implementation of a system using a secure time reference in accordance with one embodiment of the present invention.

FIG. 7 illustrates one implementation of a process generating and using a secure time reference in accordance with one embodiment of the present invention.

### SPECIFICATION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Some portions of the detailed descriptions that follow are presented in terms of procedures, logic blocks, processing, and other symbolic representations of operations on data bits within a computer. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “setting,” “storing,” “scanning,” “receiving,” “sending,” “disregarding,” “entering,” or the like, refer to the action and processes of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

### DETAILED DESCRIPTION

For the purpose of illustrating the concepts presented in this embodiment of the present invention, the term “content” will refer to a cinema film that is in a deliverable format. As such, it will be typical of copyrighted digital content that is delivered to the consumer for subsequent playback. It is within this scenario that the illustration here of this embodiment may best be appreciated. Other embodiments of the present invention, however, may address music, books, magazines, voice presentations or any other material consisting of intellectual property that is protectable by copyright. Embodiments also address uses not involving copyrighted intellectual property but which still require access to a secure, non-local, time reference.

Protection of the intellectual property within a movie, or any other intellectual construction, has always been of significant importance to those who compose, develop and own such property. The concept of copyright was developed in a time when the only recording medium was paper and the only method of copying a recorded document was by arduously producing another paper copy. The invention of the printing press, typewriter, photography, audio recording devices, movie technology, xerography, video tape, computer memory and storage, and the internet, have each continued to erode the effectiveness of copyright laws. Because digital media can be easily transmitted worldwide and recorded by use of the internet, copy protection laws are not sufficiently effective. Producers of digital intellectual property have had to develop technical copy protection in the media itself.

One means of protecting against illicit playback and/or copying of digitized content is by inserting restrictive coding into the digital data stream. Since the digital data stream must be decoded by a processor in order to be converted to a visual or audio format, commands can be inserted that disable copying, and possibly playback. In order to properly respond to the instructions, the content player must be enabled with a device that reads the coding correctly and most types of content playing devices are constructed to do so.

Found within the various code-protection schemes is the use of time as a determinant of whether the content can be legitimately played. In this method, coding is inserted that requires that certain time parameters be met before playback (e.g. decoding) is enabled.

Embodiments of the present invention that are presented here deal with the use of time as a controlling determinant. The scenario that is most illustrative of the concept is that of a movie rental. Though by no means limited to rental of electronically delivered movies, the present invention is best illustrated by such an embodiment.

In conventional video rental, a consumer goes to a video rental store and physically carries away a video tape or DVD. To do so, the renter has paid a certain amount of money and has agreed to return the video, in its physical manifestation, within a certain amount of time. Generally, the renter has also left a credit card account number with the video store so that the account can automatically be charged more rental fees should the video be returned late. What the consumer has paid for is not the physical tape or DVD, but the right to watch the movie as much as he or she wants to for the specified rental period. Indeed, the actual material cost of a recorded DVD is mere pennies and there could even be a market for one-way package delivery rental.

With online, cable, or satellite channel rental, the only thing that changes is the means by which the movie, the intellectual content, arrives at the renter's place of viewing. It arrives electronically instead of in a physical package. Without a physical package to control, the ability of the renting agency to determine that a renter is obeying an agreement to stop watching the movie is limited.

With this embodiment of the present invention, a means by which a rental period can be remotely enforced is disclosed. In this embodiment, the digital bit stream in which the content is presented includes an instruction to inhibit playback if a clock indicates a time period outside of specified parameters. For instance, if the movie were rented for 24 hours, it would be delivered to the renter's content player, possibly a computerized video player, and recorded for later playback. If, when the renter elects to watch the movie, the time parameters are met, the movie plays normally. If the time parameters are not met, then playback is inhibited and the movie cannot be watched at all.

All modern computers have built-in clocks and the time-constraint coding outlined above could reference the internal clock. However, local internal clocks can be reset by the user to any time or date within the clock's capability. In this way, the playback protection coding could be spoofed and not provide any protection at all.

This embodiment of the present invention presents a means of providing a time reference, including both time of day and date, that is not spoofable, or liable to unauthorized adjustment. This embodiment does so by use of an external “time server” which provides a secure time reference signal to content players so connected.

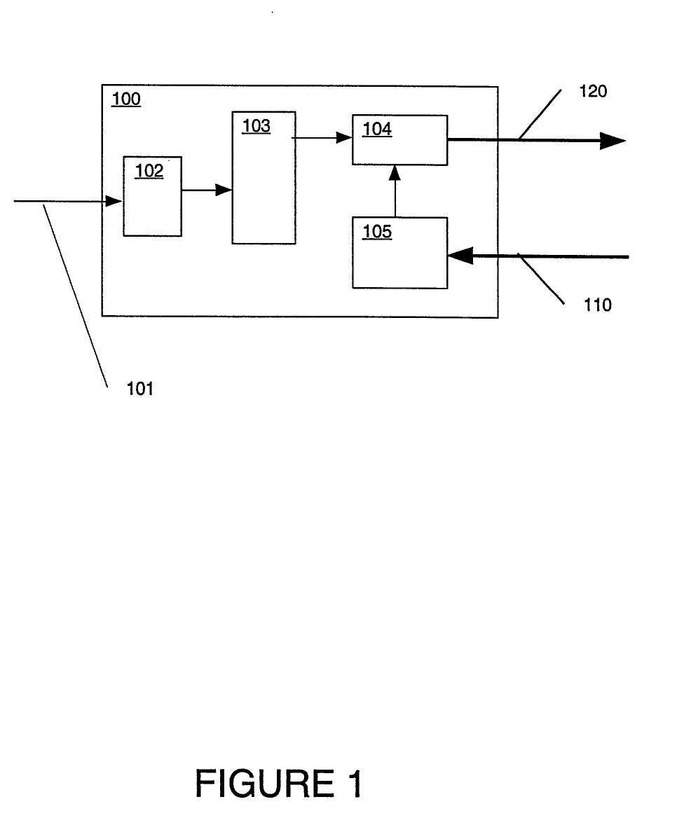

An exemplary time server is illustrated in FIG. 1 where time server 100 comprises clock signal source 102, time reference encryption device 103 and transmitting device 104. Transmitter 104 transmits encrypted time reference 120 to a remotely located content player. Some implementations of time server 100 can also comprise receiving and decryption device 105 which receives encrypted time query 110 which can emanate from the remote content player. One or more remote content players may communicate with the same time server. Other implementations may have the capability of receiving a National Time Reference code 101, continuously generated by a governmental agency, which would enable applications that require a very accurate time reference.

Time server 100 is shown only for conceptual illustration of the embodiment discussed herein. Other embodiments of the present invention may employ other configurations of time servers which accomplish the same function of providing a secure time reference.

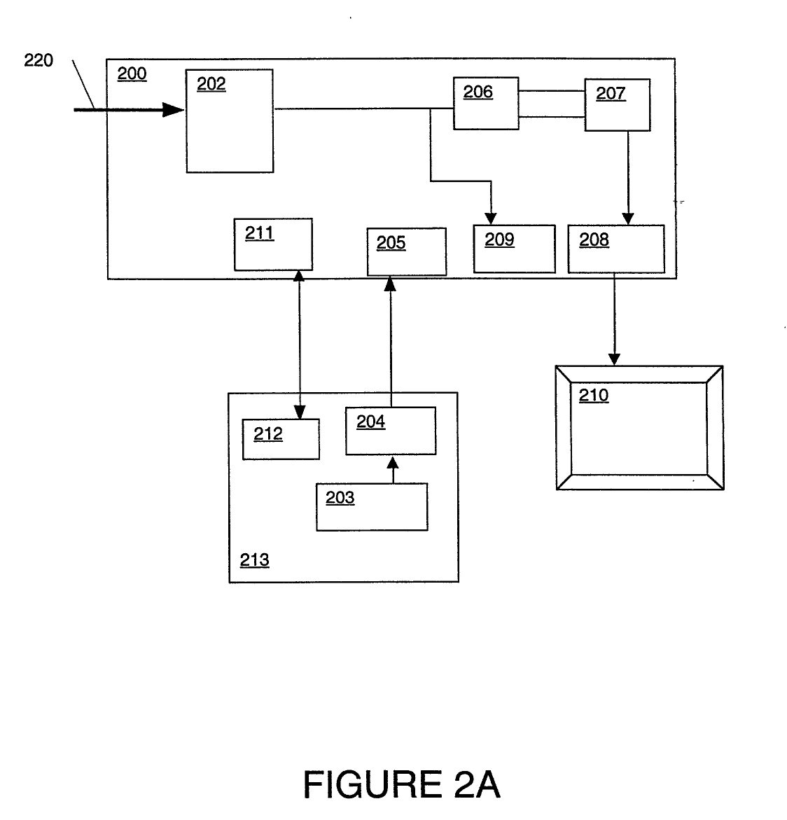

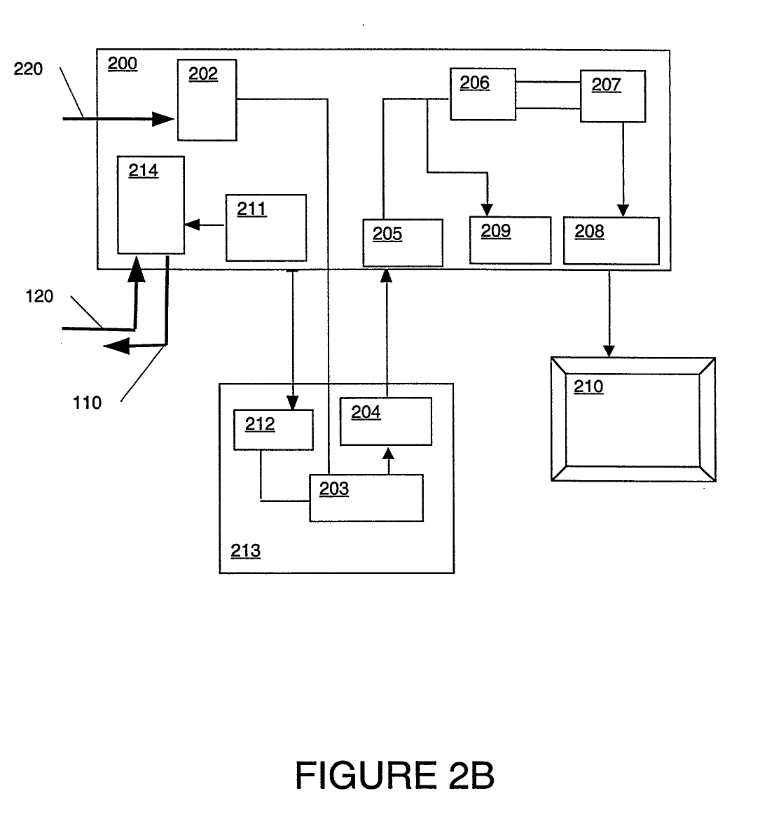

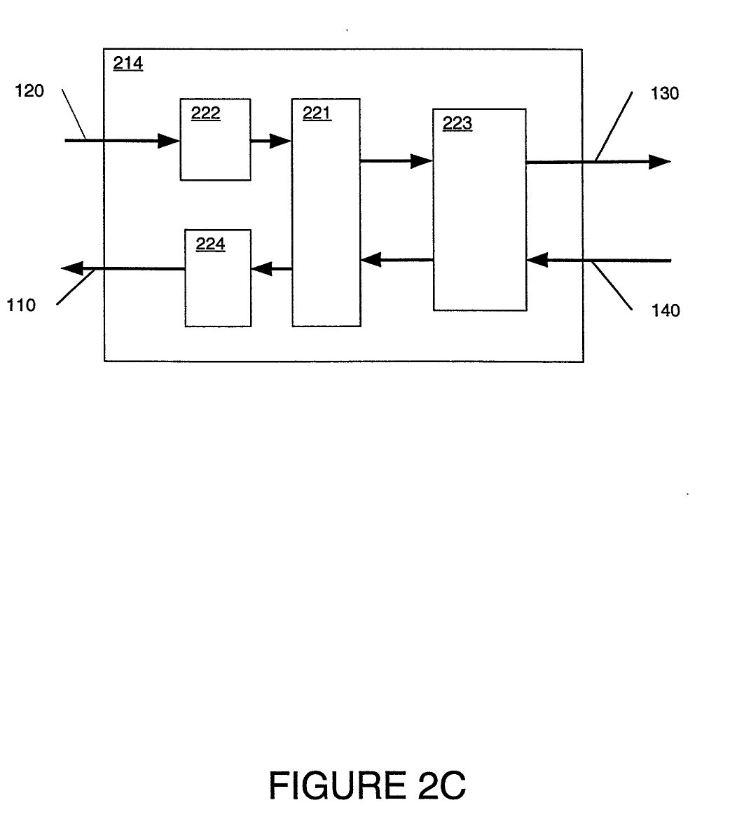

In order to use time server 100 of FIG. 1, a content player would need to receive, decrypt and use its time reference signal. By way of comparison, an exemplary content player that does not receive a time reference signal is illustrated in FIG. 2A. There, incoming content, whether delivered by cable, internet connection, direct satellite downlink, or in package form such as a video tape or a compact digital video disc (DVD), is represented by incoming media 220. For the purpose of illustration of this embodiment of the present invention, the process of playing a movie recorded on a DVD, and presenting it on a home user's DVD player, is lightly discussed here.

A tuner or a media reader 202 converts the laser readable media into computer bus voltages. Since a movie on DVD is generally in compressed format, the digital bit stream must be decoded by a decoder. Decoding of the movie in this illustration is by MPEG decoder 206. Audio and video analog voltages are produced by the player's onboard graphics and audio interface circuits, represented at 207 and 208. The movie is then viewed on display 210 via video interface 208. These processes are controlled by the player's onboard CPU 211. Also shown is conditional access (CA) module 213. This exemplary module is shown with its own CPU 212, conditional access descrambler 203 and copy protection (CP) scrambling module 204 which interfaces in this implementation with the player's copy protection descrambling circuit 205. The CA module would be employed if the content were delivered in a scrambled mode by cable or direct satellite downlink. Scrambling is one of several existing means of protection of intellectual property and both cable and satellite channel providers use it extensively to restrict viewing to paid subscribers.

With the embodiment of the present invention discussed here, the content player takes on an additional means of protection of intellectual property. With the addition of a means of reading a secure, non-local time reference, the content player can be inhibited from descrambling and presenting the intellectual content if the content owner's prescribed time constraints are not met. A content player enabled in accordance with an embodiment of the present invention to provide this capability is illustrated in FIG. 2B.

The content player in FIG. 2B is analogous to the one in FIG. 2A with the exception of the addition of a time reference module, 214, and the use of CA module 213. Here, the delivered content is read as before but coding contained in the content directs the data stream through CA module 213's CA descrambler. The CA module then either descrambles the content or not, depending on instructions from time reference module 214 via CPU 211 and CPU 212. It is time reference module 214 that is directly applicable to this embodiment of the present invention. Time reference module 214 is illustrated in FIG. 2C.

Time Reference module 214 requires the ability to receive a time reference signal, 120, represented by receiving device 222. Decryption of the signal is accomplished by encryption/decryption device 221 which, via interface 223, relays the time in decrypted format, 130, to the content player and Conditional Access module as required by the application.

In the implementation in which 'the time reference signal is only received after a query from the content player, time reference module 214 would generate the query on an instruction from the CA module, 140, through interface 223. The query is encrypted by encryption/decryption device 221 and encrypted time query 110 is transmitted to the time server by transmitting device 224.

It must be remembered that, in each of the modes of delivery pertinent to these embodiments, recording of the delivered content is not inhibited. It is simultaneous or subsequent playback that is likely to be constrained.

Again, it is appreciated that these modules and devices are only shown for purpose of illustration. The actual implementation of the concepts discussed here may be achieved through a wide variety of implementations.

In this embodiment of the present invention, the secure time reference signal is transmitted by the time server to the content player on receipt of a secure time query. The encryption of the time query is accomplished by the use of the time server's public encryption key, known to both the receiving and source systems. The receiving apparatus, the consumer's content player in this embodiment, uses the public key to encrypt a random number of its own choosing which accompanies the time query. The encrypted time query and random number are transmitted to the time server via whatever means are associated with the system being used. Many means of transmission may be used, whether by internet, cable, telephone system, satellite uplink and downlink, or any other means.

The time server receives and decrypts the encrypted time query and random number using the public key. To achieve good security, it is expected that the public key and the associated communication addressing would be kept secure within the security perimeter, the circle of receivers and time servers involved in the arrangement.

The time server then responds to a properly presented time query with the time code and the player-generated random number, which are both encrypted using the time server's private encryption key. The receiving apparatus decrypts the time code and the random number using the public key. In this embodiment, the random number is checked to be sure it is the one sent with the query in order to prevent hacking of the system. If the time code is properly verified, it is used to process the access criteria associated with the desired content playback.

In this embodiment, a public key/private key encryption scheme is employed. The purpose for this is to prevent the insertion of pseudo time codes into the system and spoofing the content player. Since only the time server has access to the private code, only it can encrypt the proper time code format and random number. There may be other embodiments that do not use the random number technique that are equally secure. There may also be other embodiments that use a different encryption technique.

The application of the time reference signal discussed in this embodiment of the present invention is envisioned as being used to control intellectual property. Other embodiments may address other applications that also have a need for a secure time reference.

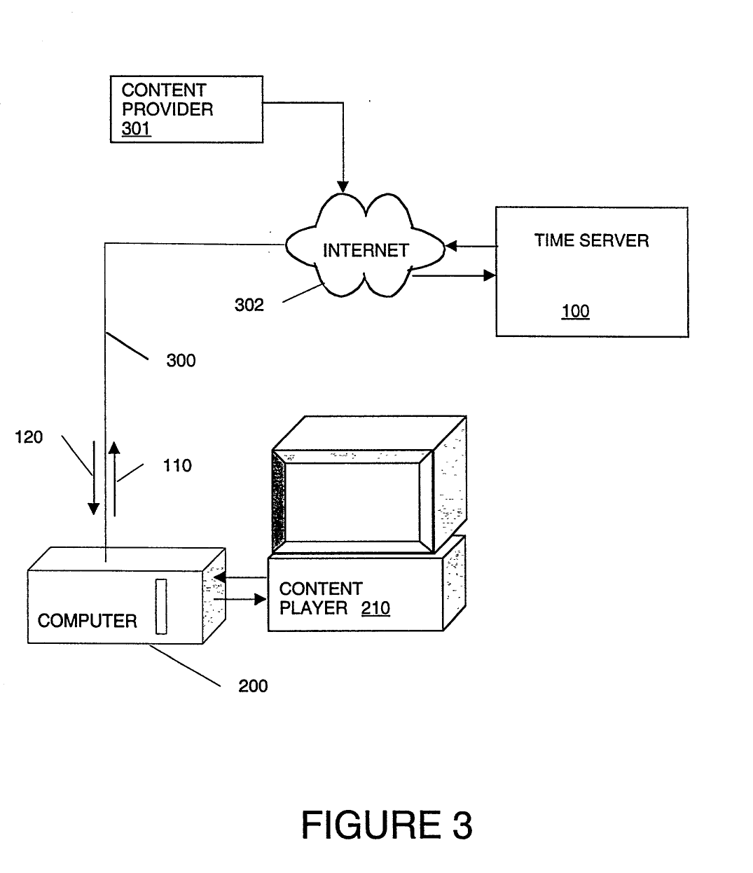

The need for control of intellectual property is, as was stated earlier, best illustrated by application to the electronic delivery of content that is restricted as to time of available playback. This is likely to be, though not limited to, online movie rental. Such an application is illustrated in FIG. 3.

A possible sequence of events, using the concepts presented in this embodiment of the present invention, would start by a home user's acquiring delivery of content, provided by a content provider 301, via internet connection 300. Again, for the sake of this example,-the content is a rented movie and content provider 301 could be any one of uncounted content providers. The movie is recorded on the user's home computer system 200, which possibly physically includes content player 210, for later playback. When desired, playback is requested and time query code 110, including the random number, is generated, encrypted using the time server's public key, and transmitted to time server 100. Here the time query is transmitted via the same internet connection by which the content was delivered. However, the query could also be sent, and the time code received, by means of an alternative telephone connection or other means not requiring continued internet connection.

When time server 100 receives the time query, it follows the decryption and the time signal/random number encryption process discussed above and the encrypted time reference is sent to the receiving apparatus, in this example the user's computer system. Again, computer system 200, content player 210, CA module 213 and time reference module 214 may all be implemented in any number of ways, including being integrated into a single unit. On receipt, the system decrypts and checks the random number and time reference signal and, if the content's encoded time constraints are met, commands a playback on content player 210.

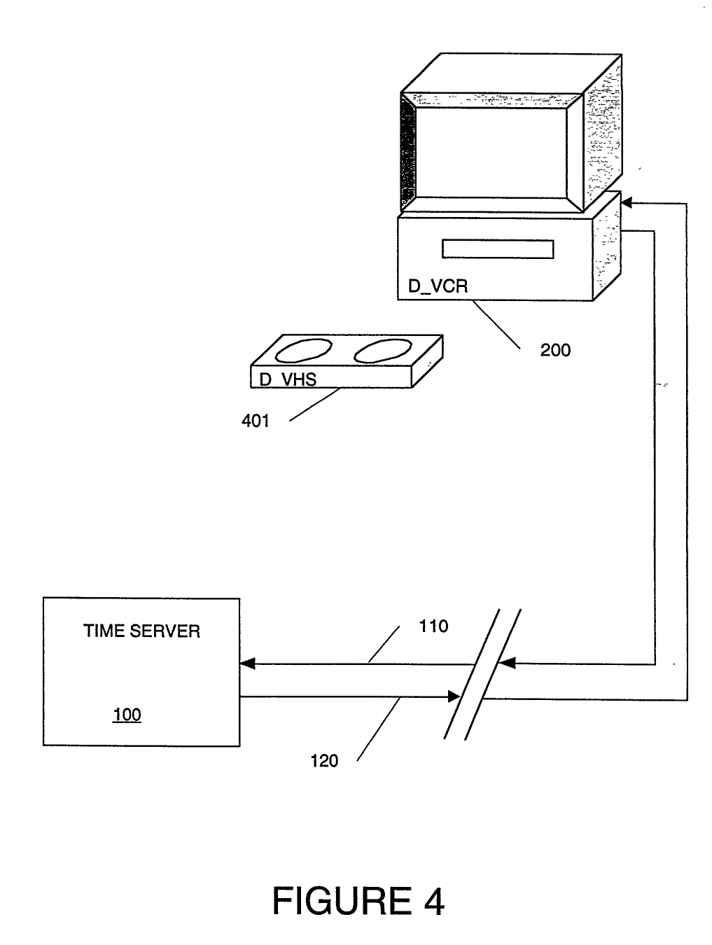

An alternative means of content delivery is illustrated in FIG. 4. There, a digital movie is delivered in a physical package. This could come about by a process of movie rental that uses a one-way package delivery in which the renter pays for the rental by credit card and receives the physical package, possibly a DVHS or DVD format. Encoded in the delivered package would be the playback time constraints consistent with the rental agreement. Once the rental period is passed, the time, as determined by the secure time reference signal which is obtained as outlined above, does not meet the time limits imposed by the encoded constraints and the movie is unwatchable.

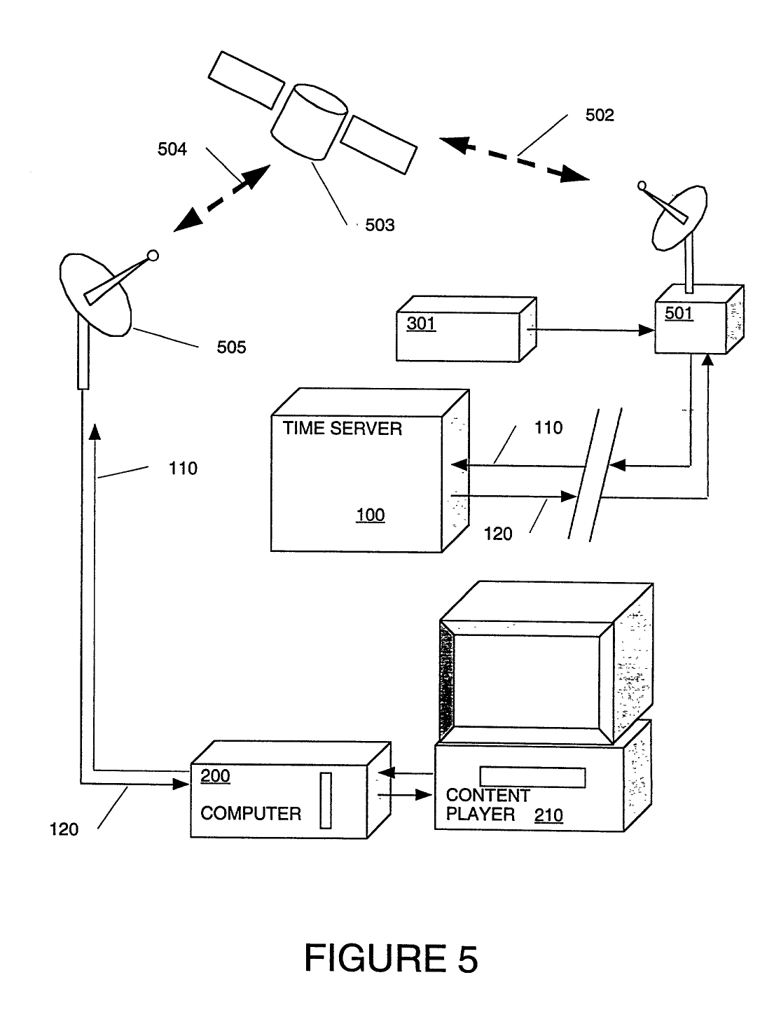

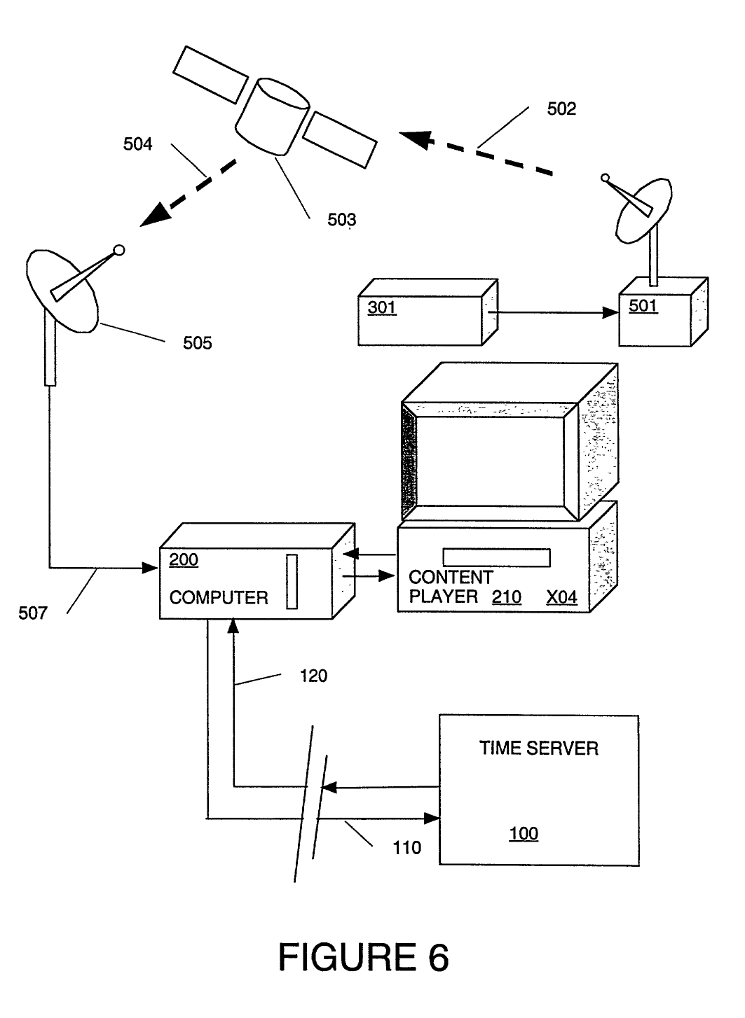

Yet another scenario, that of content delivery by direct satellite link, is illustrated by FIGS. 5 and 6. As in the previous example, the content is delivered and stored for later playback on the user's system. In this illustration, however, the delivery is by satellite links. In FIG. 5, content from content provider 301 is delivered to satellite system 501 and sent via link 502, satellite 503 and link 504 to the user's receiving antenna 505. From there it is stored on the user's home system just as in the internet-connected example. When playback is desired, however, the time query is-transmitted via the same satellite link to time server 100 which is also connected to the satellite system provider. The process of playback control in this illustration is analogous to that previously discussed. The only difference here is in the use of the satellite linkage to provide both content delivery and time reference signal delivery.

In FIG. 6, content delivery is also by satellite linkage but time reference signal delivery is by an alternative means. A telephone connection, possibly used only at the start of playback, could be used, as well as an internet connection. Some other alternative means could also be employed. In any case, it is the concept of secure, non-local, time reference that is important.

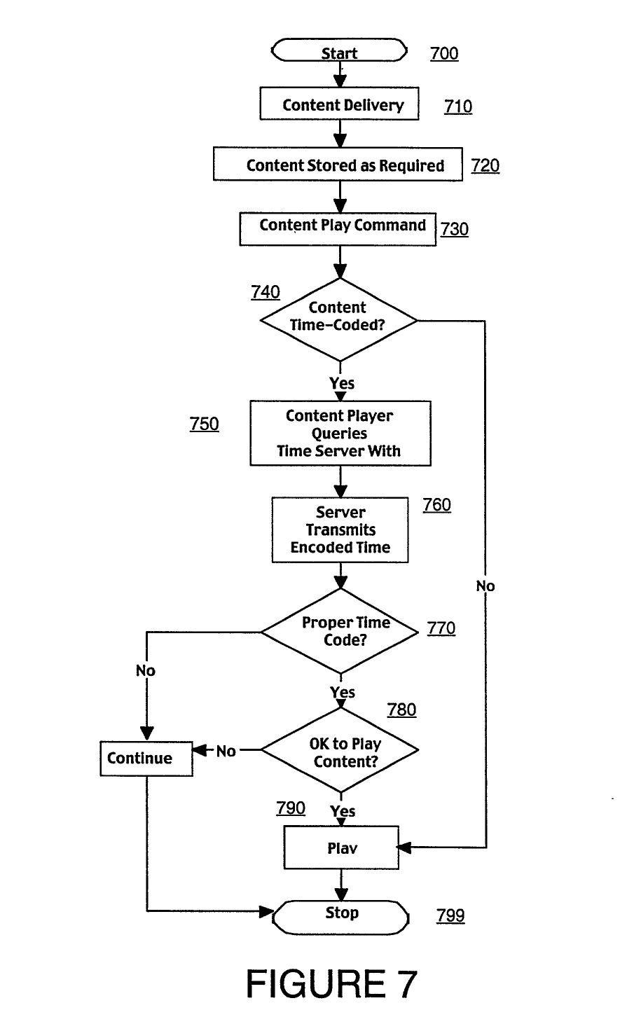

FIG. 7 illustrates, in flow chart format, a possible process that could be employed in any of the above scenarios or in many that are not discussed but would be included in the realm of possibilities. At start 700, content is delivered, 710, and stored as required, 720. When playback is requested, 730, the content is checked for access restrictions involving time, 740. If there are no time based restrictions, the content is played as requested, 790.

If time-based restrictions exist, the content playing system, which could be a dedicated content player or a computer system or any of a number of possible implementations, generates, encodes and transmits a time query code, 750. The time server responds to the query and returns the time reference signal and the original random number sent with the time query, 760. The receiving system then validates the time reference signal, by use of the random number comparison in this embodiment, at 770. If the time reference is not valid the content will not be played. If the reference signal is valid, the time restraints are checked for an OK to play, 780, and, if the constraints are met, the content is played at 790. This process can vary, depending on the application. However, the concept behind the delivery of a secure time reference signal is the same here and throughout the illustrations above.

The generation and delivery of a secure, non-local, non-spoofable, time reference signal has been described. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A method for providing a secure time reference, comprising the steps of:
a) generating a clock signal at a source;
b) encrypting said clock signal;
c) transmitting said encrypted clock signal to a remote content playing apparatus;
d) receiving said encrypted clock signal at said remote content playing apparatus;
e) decrypting said encrypted clock signal at said remote content playing apparatus; and,
f) altering the playability of content on said remote content playing apparatus by reference to said clock signal and a set of timing playback constraints specific to said content.

2. A method as described in claim 1, wherein said clock signal comprises a date signal.

3. A method as described in claim 1, wherein said clock signal comprises a time-of-day signal.

4. A method as described in claim 1, wherein said clock signal is encrypted by use of a process comprising a private key.

5. A method as described in claim 1, further comprising the step of said remote content playing apparatus transmitting a query code to said source and wherein said query code is encrypted by use of a process comprising a public key.

6. A method as described in claim 1, wherein said step of transmitting said encrypted clock signal by said source is in response to a transmitted query.

7. A method as described in claim 1, wherein said step of transmitting said encrypted clock signal is done by use of a process comprising use of the internet.

8. A method as described in claim 1, wherein said step of transmitting said encrypted clock signal is done by use of a process comprising satellite technology.

9. A method as described in claim 1, wherein said step of transmitting said encrypted clock signal is done by use of a process comprising use of a telephone system.

10. A method as described in claim 1, wherein said step of receiving said encrypted clock signal at said remote content playing apparatus is done by use of a process comprising use of the internet.

11. A method as described in claim 1, wherein said step of receiving said encrypted clock signal at said remote content playing apparatus is done by use of a process comprising use of satellite technology.

12. A method as described in claim 1, wherein said step of receiving of said encrypted clock signal at said remote content playing apparatus is done by use of a process comprising use of a telephone system.

13. A method as described in claim 1, wherein said clock signal is decrypted at said remote content playing apparatus by use of a process comprising use of a public key.

14. A method as described in claim 1, wherein said content comprises intellectual property protected by copyright.

15. A source apparatus capable of transmitting a clock signal comprising:
c) a clock signal source device capable of generating said clock signal;
d) an encryption device, coupled with said source device, wherein said encryption device is capable of encrypting said clock signal; and,
e) a transmitting device, coupled with said source device and said encryption device, wherein said transmitting device is capable of transmitting said encrypted clock signal to a remote content playing apparatus in response to a time query therefrom.

16. A source apparatus as described in claim 15, wherein said encryption device is capable of encrypting said clock signal by use of a process comprising a private key.

17. A source apparatus as described in claim 15, wherein said source apparatus further comprises a query receiving device capable of receiving and decrypting said time query.

18. A source apparatus as described in claim 15, wherein said transmitting device is capable of transmitting said encrypted clock signal by use of a process comprising use of the internet.

19. A source apparatus as described in claim 15, wherein said transmitting device is capable of transmitting said encrypted clock signal by use of a process comprising use of satellite technology.

20. A source apparatus as described in claim 15, wherein said transmitting device is capable of transmitting said encrypted clock signal by use of a process comprising use of a telephone system.

21. A receiving apparatus, comprising:
a) a receiving device capable of receiving a transmitted, encrypted, clock signal from an external source;
b) a decryption device, coupled with said receiving device, wherein said decryption device is capable of decrypting said clock signal; and,
c) a content playing device capable of rendering digitized content;
wherein said content playing device is adapted to control the playback of said content by reference to said clock signal and to a set of time constraints pertinent to said content.

22. A receiving apparatus as described in claim 21, wherein said content playing apparatus further comprises a query code source device capable of generating and transmitting a time query code.

23. A receiving apparatus as described in claim 21, wherein said receiving device is capable of receiving said encrypted clock signal by use of a process comprising use of the internet.

24. A receiving apparatus as described in claim 21, wherein said receiving device is capable of receiving said encrypted clock signal by use of a process comprising use of satellite technology.

25. A receiving apparatus as described in claim 21, wherein said receiving device is capable of receiving said encrypted clock signal by use of a process comprising use of a telephone system.

26. A receiving apparatus as described in claim 21, wherein said decryption device is capable of decrypting said clock signal by use of a process comprising a private key.

27. A receiving apparatus as described in claim 21, wherein said content playing device is adapted to alter the playback of said content by reference to said clock signal and to said set of time constraints.

28. A system for controlling the playback of content by use of a time reference signal comprising:
a) a source apparatus capable of transmitting a clock signal, said source apparatus further comprising:
a1) a clock signal source device capable of generating said clock signal;
a2) an encryption device, coupled with said source device, wherein said encryption device is capable of encrypting said clock signal;
a3) a transmitting device, coupled with said source device and said encryption device, wherein said transmitting device is capable of transmitting said encrypted clock signal to a remote content playing apparatus; and,
a4) a query receiving device capable of receiving and decrypting a remote time query.
b) a receiving apparatus, communicatively coupled with said source apparatus, wherein said receiving apparatus is capable of receiving a clock signal, and wherein said receiving apparatus comprises:
b1) a receiving device;
b2) a decryption device, coupled with said receiving device; and,
b3) a content playing device, coupled with said receiving device and with said decryption device,
wherein said receiving apparatus is adapted to receive and decrypt a clock signal and wherein said content playing device is adapted to control the playback of content by reference to said clock signal and to time constraints pertinent to said content.

29. A system as described in claim 28, wherein said source apparatus is adapted to encrypt said clock signal by use of a process comprising a private key technique.

30. A system as described in claim 28, wherein said source apparatus is adapted to decrypt said time query code by use of a process comprising a public key technique.

31. A system as described in claim 28, wherein said source apparatus is adapted to transmit said clock signal in response to said time query code.

32. A system as described in claim 28, wherein said source apparatus is adapted to transmit said encrypted clock signal by use of a process comprising use of the internet.

33. A system as described in claim 28, wherein said source apparatus is adapted to transmit said encrypted clock signal by use of a process comprising satellite technology.
